(19) United States
(12) Patent Application Publication
(10) Pub. No.: US 2026/0311584 A1
(43) Pub. Date: Oct. 8, 2026

(54) SYSTEMS AND METHODS FOR IOT SEWER MANAGEMENT

(71) Applicant: ARDURRA GROUP, INC., Miami, FL (US)

(72) Inventor: William KUEHNE, Houston, TX (US)

(21) Appl. No.: 19/171,763

(22) Filed: Apr. 7, 2025

(51) Int. Cl. G08B 21/18; E03F 7/12; G16Y 10/35

(52) U.S. Cl. CPC G08B 21/182; E03F 7/12; G16Y 10/35

(57) ABSTRACT

Disclosed are systems and methods of a decision intelligence (DI)-based computerized framework that automatically and/or dynamically monitors, controls and manages storm assets based on detected and/or predicted real-world conditions. The disclosed framework provides a smart alert, IoT-based system for monitoring, managing and controlling stormwater and sewer infrastructure. The framework utilizes IoT technology and sensors to detect issues in real time, automatically alert maintenance personnel, and automate certain responses. The framework can involve a combination of IoT sensors, data transmission networks, and centralized software for analysis and alert generation. Such components can function in connection with each other to monitor the physical conditions within the system and provide early warnings when problems arise, as well as operate to automatically and/or dynamically function to mitigate issues corresponding to such problems/warnings.

### FIELD OF THE DISCLOSURE

The present disclosure is generally related to an Internet of Things (IoT)-based management of asset cycles, and more particularly, to a decision intelligence (DI)-based computerized framework that automatically and/or dynamically monitors, controls and manages storm assets based on detected and/or predicted real-world conditions.

### SUMMARY OF THE DISCLOSURE

According to some embodiments, disclosed are systems and methods for a smart alert framework for monitoring, managing and controlling stormwater and sewer infrastructure. As discussed herein, the disclosed framework provides an innovative technical solution aimed at addressing the growing challenges of managing water systems (e.g., urban water systems, for example, although it should not be construed as limited to such types of water systems).

By way of background, as cities expand and climate change increases the intensity of storms, sewer and stormwater systems face greater risks of overload, blockages, and damage. Traditional systems often rely on periodic manual inspections or reactive maintenance, where issues are addressed only after a problem (such as a clog or flood) occurs. These systems, however, are not accurate, efficient, and are only reactive, in that they cannot predict and/or operate to mitigate detected and/or anticipated issues/faults.

Accordingly, disclosed is a smart monitoring framework that utilizes IoT technology and sensors to detect issues in real time, automatically alert maintenance personnel and/or automate certain responses. As discussed herein, the disclosed framework for stormwater and sewer management can involve a combination of IoT sensors, data transmission networks, and centralized software for analysis and alert generation. Such components can function in connection with each other to monitor the physical conditions within the system and provide early warnings when problems arise, as well as operate to automatically and/or dynamically function to mitigate issues corresponding to such problems/warnings.

According to some embodiments, a method is disclosed that automatically and/or dynamically monitors, controls and manages storm assets and/or equipment based on detected and/or predicted real-world conditions. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method that automatically and/or dynamically monitors, controls and manages storm assets and/or equipment based on detected and/or predicted real-world conditions.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub -networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed framework operates via implementation and reliance upon IoT sensors' monitoring functionality. Such sensors can continuously (and/or periodically) collect data on various parameters within the stormwater or sewer network. Such sensors, as provided below, can include, but are not limited to flow sensors, level sensors, pressure sensors, tension or force sensors, gas sensors, and the like. Such are designed to operate in harsh environments, withstanding moisture, corrosion and debris common in sewer and stormwater systems.

As provided below, in some embodiments, the data collected by such sensors can be transmitted wirelessly through wireless networks and/or radio frequencies to a centralized location (e.g., server, device and/or platform, as provided below). The transmission happens in real time, allowing immediate detection and reporting of any abnormalities. For example, in a stormwater system, a sensor installed in a drain could detect rising water levels as a storm begins. This information would be transmitted to the central server, where operation software, as provided via the disclosed framework (e.g., engine 200, discussed infra) can analyze such data to determine whether the water level is approaching a critical point that could cause flooding. In another non-limiting example, tension sensors installed in trash collection devices in stormwater systems can detect excessive buildup of debris; therefore, as the tension in the trash collection unit increases, the data is sent via cellular or Wi-Fi networks to alert maintenance crews that the system requires cleaning.

Accordingly, the disclosed framework can operate to detect when certain conditions, such as, for example, blockages, high water levels, debris accumulation, and the like, warrant a response (e.g., water levels reach and/or exceed threshold levels, for example). For example, alerts can be triggered when water levels rise above 80% pipe capacity, or when pressure exceeds normal operating limits, or when debris exceeds a specific weight. As provided below, the executable application performing such sensor control, and analysis and determinations therefrom can be hosted on a network, on the edge of a network, and/or on/at a device/sensor at the location.

According to some embodiments, as discussed herein, once an issue is detected or predicted, the disclosed framework can cause an alert to be communication, which can cause and/or enable mitigation of such issue. For example, such alert can include, but is not limited to, a location of the issue (e.g., a specific pipe or manhole); a type of issue detected (e.g., high water level, debris buildup, gas detection), a severity of the issue (e.g., critical, warning), recommended actions (e.g., send a maintenance crew, clear trash from the grate), and the like. As provided below, such alerts can be provided via an electronic message (e.g., SMS, email, dedicated mobile application notifications, and the like).

In some embodiments, such alert can be sent to maintenance personnel, which can, for example, provide them with compiled instructions of mitigating a detailed/outlined issue.

In some embodiments, such alert can cause automatic operation to mitigate the issue (e.g., close a value preventing water flow, for example). By example, in flood-prone areas, sensors detecting rising water levels can automatically trigger the closing or opening of valves to divert water to safer locations or secondary storage areas, helping to prevent flooding. In another non-limiting example, systems can be equipped with mechanical devices that automatically clear debris from stormwater grates when trash levels reach a certain threshold (e.g., which can prevent blockages without requiring manual intervention). And in yet another non-limiting example, if/when sensors detect that a stormwater system is nearing capacity, automated pumps can be activated to move water to backup reservoirs or retention ponds, reducing the load on the primary system. Thus, such automated responses help reduce the need for human intervention, especially during critical situations such as heavy storms or sudden blockages. Indeed, they can accurately and efficiently operate the at-issue components of an infrastructure to mitigate such issues, which can evidence a more safe and secure, and resource efficient (e.g., increased cost-efficiency) operational management framework for such systems.

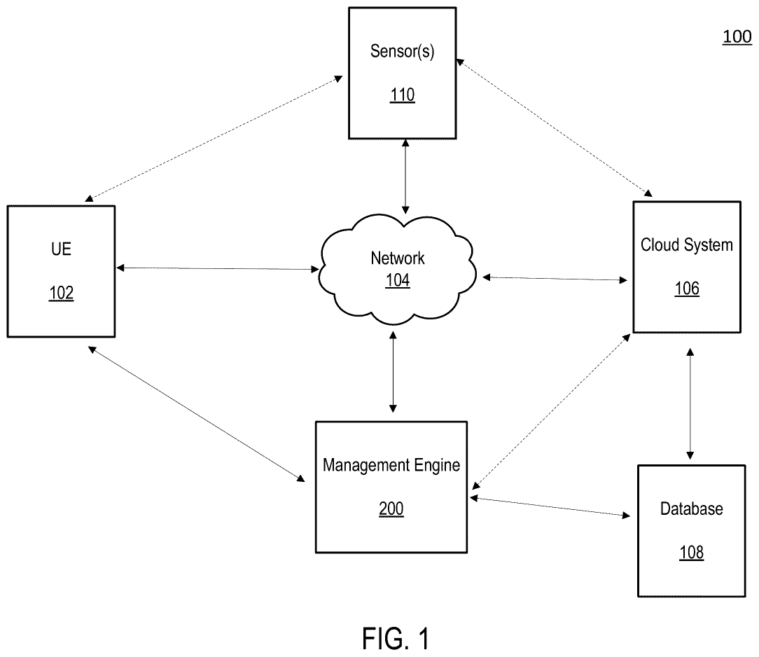

With reference to FIG. 1, a system is depicted for a sewer infrastructure (or location) 100 which includes user equipment (UE) 102, sensors 110, network 104, cloud system 106, database 108 and management engine 200. It should be understood that while system 100 is depicted as including such components, it should not be construed as limiting, as one of ordinary skill in the art would readily understand that varying numbers of UEs, sensors, cloud systems, databases and networks, inter alia, can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IoT) device, autonomous machine, and any other device equipped with a cellular or wireless or wired transceiver.

In some embodiments, UE 102 can be associated with and/or embodied as a sewer and/or storm device—for example, a pump (e.g., submersible pump, grinder pump, sewage ejector pump, lift station pump, and the like), flow control device (e.g., back flow preventor, check valve, gate valve, flow meter, and the like), access point and/or cover devices (e.g., manhole covers, catch basins, grates, access hitches, and the like), treatment equipment (e.g., bar screens, grift chambers, clarifiers, aeration systems, and the like), inspection equipment (e.g., CCTV cameras, pipe crawlers, sonar devices, smote testing equipment, and the like), cleaning equipment (e.g., vacuum devices/vehicles, jetting equipment, rodding machines, and the like), monitoring device (e.g., level sensors, flow monitors, pH meters, gas detectors, and the like), storage devices (e.g., retention tanks, detention tanks, underground storage chambers, and the like), filtration devices (e.g., storm filters, sediment traps, oil/water separators, debris screens, and the like), emergency equipment (e.g., bypass pumps, portable generators, emergency shut-off valves, warning systems, and the like), and the like, or some combination thereof. Accordingly, UE 102 can be any device that can be utilized for operating and/or maintaining the proper function of a sewer and/or stormwater infrastructure, preventing flooding and/or protecting public health via/from such systems.

In some embodiments, a peripheral device (not shown) can be connected to UE 102, and can be any type of peripheral device, such as, but not limited to, a wearable device (e.g., smart watch), printer, speaker, sensor, and the like. In some embodiments, a peripheral device can be any type of device that is connectable to UE 102 (and/or sensor 110) via any type of known or to be known pairing mechanism, including, but not limited to, Wi-Fi, Bluetooth™, Bluetooth Low Energy (BLE), NFC, and the like.

According to some embodiments, sensors 110 can correspond to sensors associated with a location of system 100 (e.g., a point/position within a sewer system and/or positioned along the sewer infrastructure to monitor stormwater flow, for example). In some embodiments, sensors 110 can operate for monitoring flow, detecting blockages and ensuring the overall efficiency of water management. For example, flow sensors such as ultrasonic and electromagnetic flow meters can be used. Ultrasonic flow meters employ sound waves to measure the velocity of water without direct contact, making them ideal for harsh environments. Electromagnetic flow meters measure flow by detecting changes in magnetic fields as water moves through pipes, and are well-suited for systems with high conductivity. In some embodiments, level sensors like radar and float switches can be used to monitor water levels and prevent overflow. Pressure sensors can be installed to detect changes in pipe pressure, which can signal blockages or leaks. Gas sensors, particularly for hydrogen sulfide (H₂S) and methane (CH₄), help detect dangerous gases in sewers, ensuring worker safety and preventing hazardous conditions. Temperature and humidity sensors can also be utilized to track environmental conditions in stormwater systems, enabling functionality for forecasting potential operational challenges. Such sensors 110 provide real-time data, which is critical for early detection of issues and effective maintenance planning.

In some embodiments, the sensors 110 can be, but are not limited to, temperature sensors (e.g., thermocouples, resistance temperature detectors (RTDs), thermistors, semiconductor based integrated circuits (IC), thermometers, and the like, for example) cameras, motion detectors, heat and smoke detectors, carbon monoxide (CO) and/or carbon dioxide (CO₂) detectors, PIR sensors, time-of-flight (ToF) sensors, and the like. In some embodiments, as discussed herein, the sensors 110 can involve an IoT environment and/or be associated with devices within a sewer infrastructure, as discussed above.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a system provider (e.g., utility company, municipality, government agency, public works departments, private company, and the like, for example), which has associated network resources hosted on the internet or private network (e.g., network 104), which enables (via engine 200) the sewer/stormwater management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102 and the UE 102, sensors 110, and the services and applications provided by cloud system 106 and/or management engine 200.

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

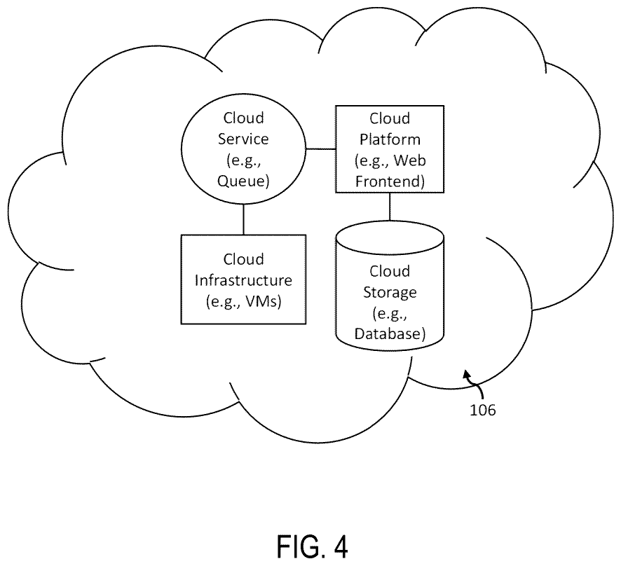

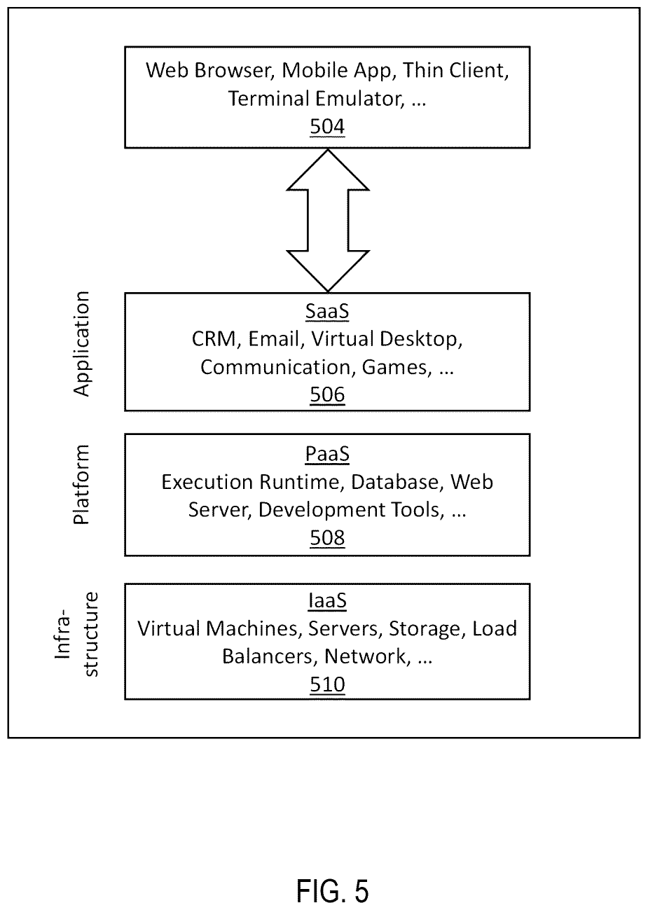

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted APIs of the present disclosure may be specifically configured to operate.

Turning back to FIG. 1, according to some embodiments, database 108 may correspond to a data storage for a platform (e.g., a network hosted platform, such as cloud system 106, as discussed supra), a plurality of platforms, and/or UE 102 and/or sensors 110. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special purpose machine or processor, and can be hosted by a device on network 104, within cloud system 106, on UE 102 (and/or on sensors 110). In some embodiments, engine 200 may be hosted by a server and/or set of servers associated with cloud system 106.

According to some embodiments, as discussed in more detail below, management engine 200 may be configured to implement and/or control a plurality of services and/or microservices, where each of the plurality of services/microservices are configured to execute a plurality of workflows associated with performing the disclosed management operations. Non-limiting embodiments of such workflows are provided below.

According to some embodiments, as discussed above, management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on sensors 110 and/or UE 102.

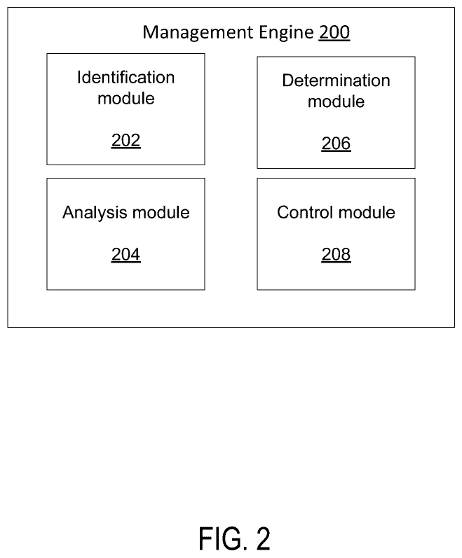

As illustrated in FIG. 2, according to some embodiments, management engine 200 includes identification module 202, analysis module 204, determination module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

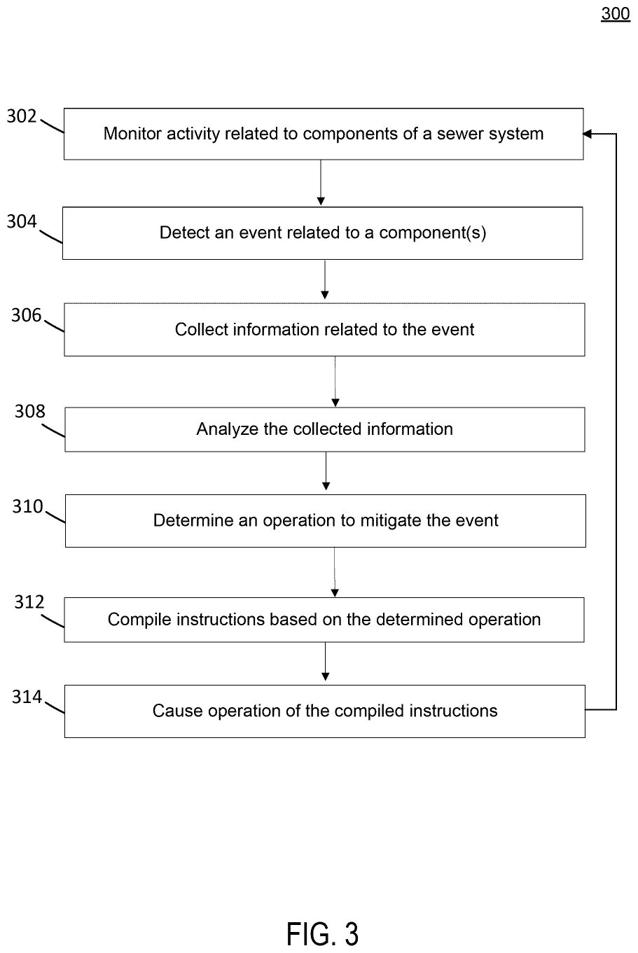

Turning to FIG. 3, Process 300 provides non-limiting example embodiments of the disclosed framework that provides features, capabilities and/or functionality for enhanced and/or improved sewer and/or stormwater management and control.

According to some embodiments, Steps 302-306 of Process 300 can be performed by identification module 202 of management engine 200; Step 308 can be performed by analysis module 204; Step 310 can be performed by determination module 206; and Steps 312 and 314 can be performed by control module 208.

According to some embodiments, Process 300 begins with Step 302 where engine 200 can monitor activity related to components of a sewer system. It should be noted that while the discussion herein may focus on a sewer system and its related components (e.g., pipes, valves, switches, and the like), it should not be construed as limiting, as any type of known or to be known water management and/or filtration system, inclusive of stormwater management systems, can be managed and controlled via the disclosed systems and methods without departing from the scope of the instant disclosure.

In some embodiments, such monitoring can occur in real-time and/or continuously via sensors 110, and/or can occur according to a criteria (e.g., based on, but not limited to, a request, time, date, location, type of debris, water level and/or other types of events, and the like). Accordingly, in some embodiments, Step 302 involves engine 200 monitoring of various components throughout the infrastructure. For example, engine 200 can utilize a network of sensors deployed at critical locations, such as, for example, sewer pipes, storm drains, manholes, catch basins, trash collection units, and the like. As discussed above, such sensors can be designed to track parameters like water flow, water levels, pressure, debris accumulation, the presence of hazardous gases, and the like, or some combination thereof.

By way of example, flow sensors can monitor how quickly water is moving through pipes, while level sensors can track the rising or falling of water in catch basins or storm drains. Pressure sensors are crucial in identifying changes within sewer pipes that could indicate a blockage or leak. Trash or tension sensors help measure the amount of debris building up in storm drains, while gas sensors monitor the concentration of potentially harmful gases like methane or hydrogen sulfide, both of which are common in sewer environments.

According to some embodiments, operations of continuous monitoring can provide locations (e.g., cities) with real-time data about the condition of their infrastructure. Therefore, instead of relying solely on scheduled inspections, engine 200 allows for an immediate understanding of the current state of the sewer and stormwater systems. Such proactive approach, inclusive of detecting any signs of irregular activity, can ensure that problems can be addressed before they lead to system failures or dangerous conditions, as discussed herein.

In Step 304, engine 200 can detect an event related to a component(s) of the sewer system. According to some embodiments, events can range from minor issues, like the slow accumulation of debris in storm drains, to more serious problems, such as flooding due to excessive rainfall or dangerous gas buildup in sewer lines. According to some embodiments, detection can occur when sensors identify that a certain parameter has crossed a predetermined threshold. For example, if a level sensor in a catch basin notices that water is rising too quickly during a heavy rainstorm, this would be flagged as an event. Similarly, if flow sensors detect a sudden decrease in water movement within a pipe, it could indicate a blockage downstream. Trash sensors might also register that debris buildup is approaching a critical point, signaling that maintenance is needed.

According to some embodiments, engine 200 can operate to analyze and differentiate between various types of events, and categorize them based on severity and urgency. For example, a minor clog in a storm drain may not require immediate attention, but the detection of hazardous gases in a sewer could prompt an urgent alert to ensure that maintenance personnel are aware of potential dangers. Such type of categorization can be based on artificial intelligence and/or machine learning (AI/ML) analysis of the event data, as discussed below. In some embodiments, such categorization can be performed based on defined rules or types of events, as discussed herein. Such early detection allows locations/entities to prioritize their responses to detected issues/problems, focusing on the most critical events first while tracking less urgent issues for future attention.

In some embodiments, data/metadata related to the detected event and/or involved component(s) of the sewer system (e.g., drain, valve, basin, for example) can be stored in database 108, as discussed supra.

In Step 306, engine 200 can collect information related to the event. Such information can include relevant data from the sensors in the affected area (e.g., sensors that were triggered for the event detection in Step 304). Such data collection provides a detailed picture of what is happening within the sewer system. For example, such information can include, but is not limited to, water levels at the time of the event, the flow rate before and after the event, the amount of debris buildup, pressure variations, air quality data related to hazardous gases, and the like.

Thus, the information can indicate, but not be limited to, component identifier (ID), event type, threshold satisfied/exceeded, time, date, location, sensor ID, sensor type, historical data of the sensor, location and/or component, and the like, or some combination thereof.

By way of non-limiting example, in some embodiments, if/when a sensor 110 detects rising water levels in a catch basin, engine 200 can collect real-time data from nearby sensors to build a comprehensive view of the situation. This can include, for example, not only water levels but also flow data from adjacent pipes to determine if the water is being drained as expected or if there is a potential blockage downstream. Thus, if a blockage is suspected, engine 200 can analyze pressure data to pinpoint the location of the obstruction.

According to some embodiments, as discussed above, in addition to real-time data, historical data from a database (e.g., database 108) can be used for comparison. For example, this can assist engine 200 in identifying whether the current event is part of a recurring issue or an isolated incident. For example, if the same section of the sewer has experienced multiple blockages in the past, engine 200 can flag this area as a potential high-risk zone, prompting more detailed monitoring or preemptive maintenance.

In some embodiments, the collected information can be stored in database 108, as discussed supra.

In Step 308, engine 200 can analyze the collected information. For example, if/when the event is related to flooding, engine 200 can analyze how quickly water levels are rising and whether the nearby drainage pipes are functioning as expected (e.g., handling a threshold amount of water per a time period (e.g., per second, for example) so as to prevent a backup along the pipe(s) and/or treatment areas, for example). By correlating data from flow sensors, level sensors, and pressure sensors, engine 200 can determine whether there is simply a temporary surge in water volume due to heavy rain or if there is a blockage in the system that requires immediate action.

In another non-limiting example, if engine 200 detects that certain storm drains tend to clog during specific weather conditions, engine 200 can proactively recommend cleaning these drains ahead of time, preventing potential problems. Thus a detected event, from Step 304, discussed supra, need not be tied to an event where an issue is arising, but as discussed above, but historically indicates an issue is imminently going to occur (e.g., occurring within k minutes or another time parameter for which remediation is required for the sewer system to function properly, for example).

Similarly, in another non-limiting example if gas sensors detect rising concentrations of hazardous gases over time, engine 200 can predict when levels might reach a dangerous point and alert maintenance crews before they enter the area.

In some embodiments, such analysis can involve engine 200 implementing any type of known or to be known computational analysis technique, algorithm, mechanism or technology to analyze the collected information from Step 306.

In some embodiments, engine 200 may include a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage a large language model (LLM), whether known or to be known. An LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the user data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 310, based on the analysis from Step 308, engine 200 can determine an operation that can mitigate (or address) the event. That is, in some embodiments, engine 200 can determine a course of action to mitigate or resolve the event, which can correspond to a type and/or metrics associated with the event. In some embodiments, the operation(s) recommended or initiated by engine 200 can be based on, but not limited to, a type of problem detected, a time of the issue, a location within the sewer system for which it is occurring, the predicted impacted areas or zones of the sewer system and/or related systems, the capabilities of both the system and the available personnel, whether automated capabilities and/or human involvement are needed for such mitigation, and the like, or some combination thereof.

By way of a non-limiting example, if/when a blockage is detected in a storm drain, engine 200 can determine operations that recommend sending a maintenance crew to clear the debris before it causes flooding. In some embodiments, for example, engine 200 can also advise on the equipment needed, such as vacuum trucks or specialized cleaning tools, depending on the severity and type of blockage.

In other non-limiting examples, engine 200 can compile instructions for operations that can automatically initiate certain automated responses. For example, if/when water levels are determined to be rising at dangerous levels (e.g., at or above a threshold level) in a catch basin, engine 200 can determine to automatically open diversion valves to reroute water to retention ponds or other safe storage areas, thereby reducing the risk of flooding. Similarly, for example, if a blockage is minor, a self-cleaning mechanism in the storm drain could be activated by engine 200 to clear the debris without human intervention.

Accordingly, the determination in Step 310 provides engine 200, and the sewer system for which it is operating, the ability to determine the right response quickly and accurately to ensure that resources are allocated efficiently, and that critical problems are addressed before they escalate into more severe issues.

Accordingly, in Step 312, based on the determinations in Step 310, engine 200 can compile executable instructions for the performance of the determined operations that can mitigate/address the detected event. Thus, once the appropriate operation is determined (as in Step 312), engine 200 can compile a set of instructions that detail the specific actions needed to resolve the event. Such instructions can be tailored to either human crews and/or automated systems, depending on the nature of the response (as determined in Step 310).

According to some embodiments, for example, for manual responses, the instructions can be compiled and delivered to maintenance crews via mobile apps or text messages, or other forms of known or to be known electronic messages (e.g., output over a public announcement (PA) system, for example). Thus, the instructions can be compiled and provided via mechanisms available at and/or in relation to the sewer system and/or the area for which mitigation is to occur.

In some embodiments, such instructions can include, but are not limited to, the location of the problem (e.g., GPS coordinates or a map of the sewer system), the type of issue (e.g., blockage, flooding, gas leak), the determined severity of the issue, which can aid crews prioritize their response, the equipment needed for the task (e.g., cleaning tools, pumps, protective gear), safety warnings—for example, how to handle the equipment, and/or if hazardous gases are present, and the like, or some combination thereof.

In some embodiments, for example, for automated systems, the compiled instructions can be configured as executable commands sent directly to the components involved in the operation. For example, a command can be issued to open a valve, activate a pump, initiate a self-cleaning cycle in a storm drain, and the like. In some embodiments, engine 200 can integrate with other infrastructure, such as traffic management systems, to divert traffic away from flooded streets or blocked areas, for example.

And, in Step 314, engine 200 can cause operation of the compiled instructions, which as provided above, can involve electronically communicating such compiled instructions to the relevant personnel and/or components/equipment. For example, if/when engine 200 identifies a blockage in a storm drain, engine 200 can issue an alert to a nearby maintenance crew (e.g., send to devices of a crew chief and/or each member of the crew, or some combination thereof, for example). The crew, guided by GPS coordinates and real-time data, can be instructed to arrive at the location with the necessary tools and equipment so that they, according to the instructions, can clear the blockage, and restore normal flow through the drain.

And, in another non-limiting example, in some embodiments, the automatically caused operations can trigger the automated actions of the instructed equipment. For example, valves can be opened/closed to divert water to backup storage areas. In another example, pumps can be activated to remove excess water from flooded streets. And, in yet another non-limiting example, self-cleaning mechanisms can be initiated to clear debris from trash collection units.

In some embodiments, when automated systems are triggered, crews may also be alerted so they are aware of the ongoing maintenance work and/or can use the proper protective gear (similar for manual interventions so other crews are aware of the performed resolution tasks).

Thus, upon completion of Step 314, engine 200 can recursively proceed back to Step 302, which can involve monitoring for future events and/or perform monitoring and related determinations for confirming the previously detected event has been mitigated/resolved (e.g., via Step 314's operation).

In some embodiments, the performance of Step 314 can further involve data visualization operations, which can involve compiling the recommended actions (as per Steps 312-314) in an intuitive manner so that officials and/or maintenance crews can view information related to the event and/or recommended actions (e.g., the provided recommendations can include displayable information, in an interactive manner within a user interface (UI), that enables viewing of information related to, but not limited to, the event, time, date, location, recommended operations, requested equipment/crews, and the like).

For example, in some embodiments, the visualization can be within a dashboard UI, which can depict maps of a city's sewer and stormwater systems, with color-coded indicators for problem areas, and interactive objects/elements that, upon interaction, can provide information related to the event and mitigation action (e.g., upon selecting an icon for a drain, the icon can show cause another window to be displayed which depicts the information about the event, and the operations being performed to cure the blockage at such drain, for example). This, for example, can make it easier for decision-makers to quickly assess the situation and determine the best course of action and/or monitor the mitigation of such events.

Accordingly, as discussed herein, the implementation of smart monitoring systems for stormwater and sewer infrastructure provides numerous benefits. For example, the disclosed framework's operation provides the ability to detect issues before they become serious. Sensors can identify blockages, rising water levels, or other anomalies in real time, allowing for preventive maintenance. This reduces the likelihood of catastrophic events such as sewer overflows or flooding, which can cause property damage, environmental pollution, and public health risks.

Moreover, the disclosed smart monitoring framework can significantly reduce the costs associated with maintaining sewer and stormwater infrastructure. For example, by detecting problems early, the need for emergency repairs is minimized, and routine maintenance can be scheduled more efficiently. Additionally, the disclosed automated mechanisms can evidence a reduction in labor costs, as fewer manual inspections are required, and as discussed above, the framework can operate resolve minor issues without human intervention.

Further, the disclosed framework can have an environmental impact by helping to reduce the amount of untreated runoff that enters natural waterways. For example, by preventing blockages and optimizing the flow of water through the system, the framework can operate to reduce the risk of contaminants entering rivers, lakes or oceans. Similarly, in sewer systems, these technologies help to prevent sewage overflows, which can have severe environmental consequences. And, by preventing sewer overflows and flooding, the disclosed framework can reduce the risk of waterborne diseases and other health hazards.

As such, as discussed herein, by combining IoT sensors, data analysis, and real-time alerts, the disclosed systems and methods provide novel capabilities and/or functionalities that enable operations for early detection of problems, automated responses and more efficient maintenance, ultimately leading to safer, cleaner and more resilient urban environments. Indeed, the disclosed framework can provide for a more sustainable water and/or sewer management.

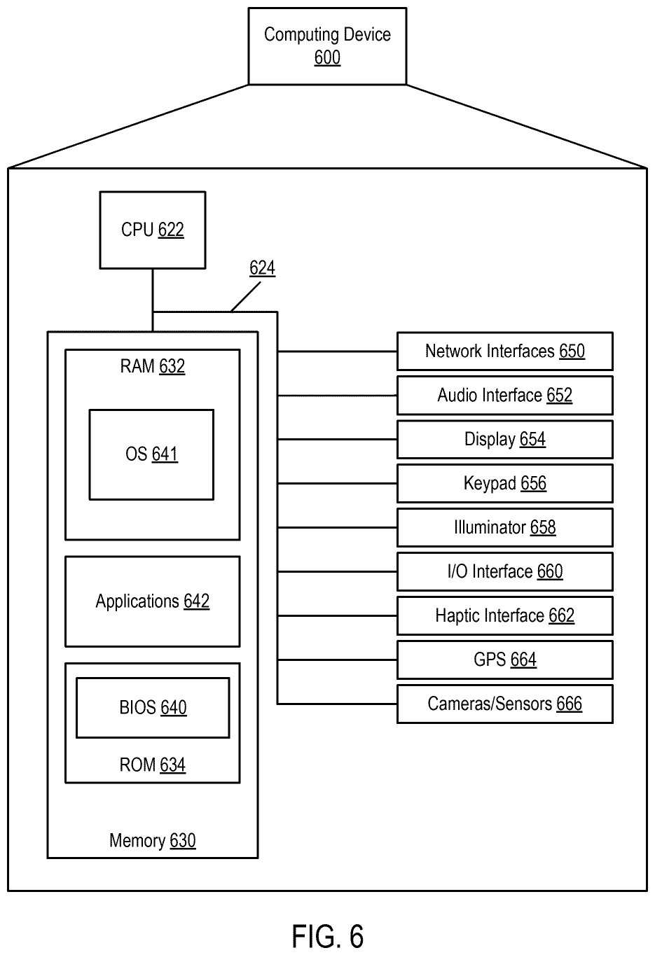

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising:
detecting, over a network, an event occurring in relation to a sewer system, the event being related to an issue associated with operation of the sewer system;
analyzing, upon detection of the event, information related to the event, the event information comprising information indicating a component of the sewer system and a cause of the issue;
determining, based on the analysis, an operation, the operation corresponding to functionality of the component so as to mitigate the issue with the operation of the sewer system; and
causing performance, over the network, of the determined operation, the performance comprising operating the functionality of the component to mitigate the issue with the sewer system.

Aspect 2. The method of aspect 1, further comprising:
determining, based on the analysis of the event information, a type of the issue and metrics related to the cause of the issue; and
performing the determination of the operation based on the determined type and determined metrics.

Aspect 3. The method of aspect 1, further comprising:
compiling, based on the determined operation, an electronic message, the electronic message comprising executable operations related to determined operation; and
communicating, over the network, the electronic message, such that the caused performance of the determined operation is based on the communication of the electronic message.

Aspect 4. The method of aspect 3, further comprising the communication of the electronic message being sent to the component, such that the caused performance comprises the component automatically executing the determined operation.

Aspect 5. The method of aspect 3, further comprising the communication of the electronic message being sent to a device of crew member, the communication enabling a visualization within a user interface (UI) of instructions related to the performance of the determined operation.

Aspect 6. The method of aspect 1, further comprising the component being selected from a group consisting of: equipment related to the sewer system, equipment used for performing maintenance of the sewer system, a part enabling the operation of the sewer system, a tool of the sewer system and hardware of the sewer system.

Aspect 7. The method of aspect 1, further comprising:
collecting, upon detection of the event, the event information from a sensor positioned within the sewer system, the sensor being at a location that corresponds to the issue.

Aspect 8. The method of aspect 1, further comprising:
monitoring, over the network, via a set of sensors positioned within the sewer system, the operation of the sewer system; and
performing the detection of the event based on the monitoring via the set of sensors.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
detecting, over a network, an event occurring in relation to a sewer system, the event being related to an issue associated with operation of the sewer system;
analyzing, upon detection of the event, information related to the event, the event information comprising information indicating a component of the sewer system and a cause of the issue;
determining, based on the analysis, an operation, the operation corresponding to functionality of the component so as to mitigate the issue with the operation of the sewer system; and
causing performance, over the network, of the determined operation, the performance comprising operating the functionality of the component to mitigate the issue with the sewer system.

2. The method of claim 1, further comprising:
determining, based on the analysis of the event information, a type of the issue and metrics related to the cause of the issue; and
performing the determination of the operation based on the determined type and determined metrics.

3. The method of claim 1, further comprising:
compiling, based on the determined operation, an electronic message, the electronic message comprising executable operations related to determined operation; and
communicating, over the network, the electronic message, such that the caused performance of the determined operation is based on the communication of the electronic message.

4. The method of claim 3, further comprising the communication of the electronic message being sent to the component, such that the caused performance comprises the component automatically executing the determined operation.

5. The method of claim 3, further comprising the communication of the electronic message being sent to a device of crew member, the communication enabling a visualization within a user interface (UI) of instructions related to the performance of the determined operation.

6. The method of claim 1, further comprising the component being selected from a group consisting of: equipment related to the sewer system, equipment used for performing maintenance of the sewer system, a part enabling the operation of the sewer system, a tool of the sewer system and hardware of the sewer system.

7. The method of claim 1, further comprising:
collecting, upon detection of the event, the event information from a sensor positioned within the sewer system, the sensor being at a location that corresponds to the issue.

8. The method of claim 1, further comprising:
monitoring, over the network, via a set of sensors positioned within the sewer system, the operation of the sewer system; and
performing the detection of the event based on the monitoring via the set of sensors.

9. A system comprising:
a processor configured to:
detect, over a network, an event occurring in relation to a sewer system, the event being related to an issue associated with operation of the sewer system;
analyze, upon detection of the event, information related to the event, the event information comprising information indicating a component of the sewer system and a cause of the issue;
determine, based on the analysis, an operation, the operation corresponding to functionality of the component so as to mitigate the issue with the operation of the sewer system; and
cause performance, over the network, of the determined operation, the performance comprising operating the functionality of the component to mitigate the issue with the sewer system.

10. The system of claim 9, wherein the processor is further configured to:
determine, based on the analysis of the event information, a type of the issue and metrics related to the cause of the issue; and
perform the determination of the operation based on the determined type and determined metrics.

11. The system of claim 9, wherein the processor is further configured to:
compile, based on the determined operation, an electronic message, the electronic message comprising executable operations related to determined operation; and
communicate, over the network, the electronic message, such that the caused performance of the determined operation is based on the communication of the electronic message.

12. The system of claim 11, wherein the processor is further configured such that the communication of the electronic message is sent to the component, such that the caused performance comprises the component automatically executing the determined operation.

13. The system of claim 11, wherein the processor is further configured such that the communication of the electronic message is sent to a device of crew member, the communication enabling a visualization within a user interface (UI) of instructions related to the performance of the determined operation.

14. The system of claim 9, wherein the processor is further configured to:
collecting, upon detection of the event, the event information from a sensor positioned within the sewer system, the sensor being at a location that corresponds to the issue.

15. A non-transitory computer-readable storage medium tangibly encoded with computer-executable instructions that when executed by a device, perform a method comprising:
detecting, over a network, an event occurring in relation to a sewer system, the event being related to an issue associated with operation of the sewer system;
analyzing, upon detection of the event, information related to the event, the event information comprising information indicating a component of the sewer system and a cause of the issue;
determining, based on the analysis, an operation, the operation corresponding to functionality of the component so as to mitigate the issue with the operation of the sewer system; and
causing performance, over the network, of the determined operation, the performance comprising operating the functionality of the component to mitigate the issue with the sewer system.

16. The non-transitory computer-readable storage medium of claim 15, further comprising:
determining, based on the analysis of the event information, a type of the issue and metrics related to the cause of the issue; and
performing the determination of the operation based on the determined type and determined metrics.

17. The non-transitory computer-readable storage medium of claim 15, further comprising:
compiling, based on the determined operation, an electronic message, the electronic message comprising executable operations related to determined operation; and
communicating, over the network, the electronic message, such that the caused performance of the determined operation is based on the communication of the electronic message.

18. The non-transitory computer-readable storage medium of claim 17, further comprising the communication of the electronic message being sent to the component, such that the caused performance comprises the component automatically executing the determined operation.

19. The non-transitory computer-readable storage medium of claim 17, further comprising the communication of the electronic message being sent to a device of crew member, the communication enabling a visualization within a user interface (UI) of instructions related to the performance of the determined operation.

20. The non-transitory computer-readable storage medium of claim 15, further comprising:
collecting, upon detection of the event, the event information from a sensor positioned within the sewer system, the sensor being at a location that corresponds to the issue.
